(19) United States
(12) Patent Application Publication
(10) Pub. No.: US 2025/0232177 A1
(43) Pub. Date: Jul. 17, 2025

(54) TRAINING MACHINE-LEARNED TRANSFORMER ARCHITECTURES BY CLIPPING QUERIES, KEYS, AND VALUES

(71) Applicant: Databricks, Inc., San Francisco, CA (US)

(72) Inventor: Vitaliy A. Chiley, San Diego, CA (US)

(21) Appl. No.: 18/414,270

(22) Filed: Jan. 16, 2024

(51) Int. Cl. G06N 3/084

(52) U.S. Cl. CPC G06N 3/084

(57) ABSTRACT

A data processing service performs a training process to train a transformer architecture including a set of decoders coupled to receive a set of inputs and generate a set of outputs. At least one decoder or encoder includes an attention block coupled to receive a query, a key, and a value and generate an attention output. For one or more iterations, the data processing service obtains a batch of training instances for a current iteration. The parameters of the transformer architecture for the current iteration are applied to a set of inputs obtained from the batch of training instances to generate a set of estimated outputs. The applying includes obtaining a query, a key, and a value from the set of inputs, and applying a clipping function to values of the query, the key, the value.

### BACKGROUND

This invention relates generally to transformer neural network architectures, and more particularly to training machine-learning transformer architectures.

A transformer neural network architecture is a deep neural network which uses attention modules or layers. In one instance, a neural network may be a universal function approximators, which can learn a function using a training process such as stochastic gradient descent (SGD). The transformer architecture can be used for a variety of generative tasks, such as text generation applications, image generation applications, and the like, as well as non-generative tasks, such as classification, detection, embedding-generation, clustering, and the like, where a function needs to be learned. A trained transformer model is configured to receive a set of inputs (e.g., text tokens, image pixels, audio signals) and generate a set of outputs. For example, a transformer architecture may receive a sequence of input tokens that represents a question and generate a sequence of output tokens that represents an answer to the question. In one instance, a transformer architecture includes a set of encoders and/or a set of decoders.

Typically, during a training process of a machine-learning model, a data processing service obtains training data including a plurality of training instances, which may include different modalities of data depending on the type of generation task the architecture is trained for. The data processing service performs a training process to train parameters of the machine-learning model by repeatedly iterating between a forward pass step and a backpropagation step. During the forward pass step, the transformer architecture generates one or more estimated outputs by applying parameters of the transformer architecture for a current iteration to a batch of training instances for the iteration. The data processing service determines a loss function indicating a difference between the one or more estimated outputs and known data in the batch of training instances. During the backpropagation step, gradients are propagated backwards through the neural network. After this a training algorithm, such as SGD or ADAM, is applied to update parameters of the machine-learning model to reduce the loss function. This process is iteratively repeated for the next batch of training instances until a convergence criterion for the parameters is reached.

Generative transformer architectures typically have a large number of parameters (e.g., greater than 1 billion, greater than 10 billion, greater than 1 trillion, etc.). Training such large models often requires distributed computation across a large set of specialized processors. Furthermore, these networks are often trained using low precision arithmetic. This results in reasonable training times, but often leads to numerically unstable training, making it difficult to actually train these networks. Specifically, during training, “loss spikes” may occur, where the loss function suddenly increases significantly and diverges, resulting in a failure in the training process. The instability occurs frequently in training large-scale architectures. One method to mitigate the instability is to adjust the learning rate whenever a loss spike occurs. However, this method is problematic as it requires shutting down hardware acceleration devices (e.g., graphics processing units (GPU's)) used for the training process, restarting the devices, and/or rewinding the training process to a checkpoint before the loss spike occurred. This results in significant waste of computational resources and time.

### SUMMARY

A data processing service performs a training process to train parameters of a machine-learned transformer architecture. In one embodiment, the transformer architecture includes a set of decoders coupled to receive a set of inputs and generate a set of outputs. In one embodiment, at least one decoder includes an attention block coupled to receive a query, a key, and a value and generate an attention output. For one or more iterations, the data processing service obtains a batch of training instances for a current iteration. The parameters of the transformer architecture for the current iteration are applied to a set of inputs obtained from the batch of training instances to generate a set of estimated outputs. In one embodiment, the applying includes obtaining a query, a key, and a value from the set of inputs, and applying a clipping function to values of the query, the key, the value. A loss function is determined. The loss function indicates a difference between data in the batch of training instances and the set of estimated outputs, and error terms obtained from the loss function are backpropagated to update the parameters of the transformer architecture. The trained transformer architecture may be deployed to an inference system.

In this manner, the loss spikes can be prevented during the training process of large-scale neural networks, and stability of the training process is improved. Moreover, many times, computations for performing inference with large-scale neural networks are divided across multiple hardware acceleration devices (e.g., GPU's) such that they can be performed in parallel for faster processing, referred to as tensor parallelism. The claimed method and system described herein allow training stability to be improved while still allowing faster processing times to be obtained through tensor parallelism during inference compared to other mitigation methods.

### BRIEF DESCRIPTION OF THE DRAWINGS

FIG. 1 is a high-level block diagram of a system environment for a data processing service, in accordance with an embodiment.

FIG. 2 illustrates a block diagram of an architecture of a data storage system, in accordance with an embodiment.

FIG. 3 illustrates a block diagram of an architecture of a control layer, in accordance with an embodiment.

FIG. 4 illustrates a block diagram of an architecture of a cluster computing system of the data layer, in accordance with an embodiment.

FIG. 5 illustrates a block diagram of an architecture of a machine learning module, in accordance with an embodiment.

FIG. 6 illustrates an architecture of a transformer architecture, in accordance with an embodiment.

FIG. 7 illustrates an architecture of an attention block of the machine-learned model with multi-head attention, in accordance with an embodiment.

FIG. 8 illustrates an example process of computing the attention layer and attention outputs on two hardware acceleration devices, in accordance with an embodiment.

FIG. 9 illustrates a flowchart for performing a method of training a transformer architecture, in accordance with an embodiment.

FIG. 10 illustrates a computer for performing the functionalities of systems and modules, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A data processing service performs a training process to train parameters of a machine-learned transformer architecture by accessing a transformer architecture including a set of decoders coupled to receive a set of inputs and generate a set of outputs. In one embodiment, at least one decoder includes an attention block coupled to receive a query, a key, and a value and generate an attention output. For one or more iterations, the data processing service obtains a batch of training instances for a current iteration. A function in the form of a transformer neural network architecture, parameterized by its weights, is applied to a set of inputs obtained from the batch of training instances to generate a set of estimated outputs. In one embodiment, the applying includes obtaining a query, a key, and a value from the set of inputs, and applying a clipping function to values of the query, the key, the value. In this manner, loss spikes can be prevented during the training process of large-scale neural networks, and stability of the training process is improved.

### System Environment

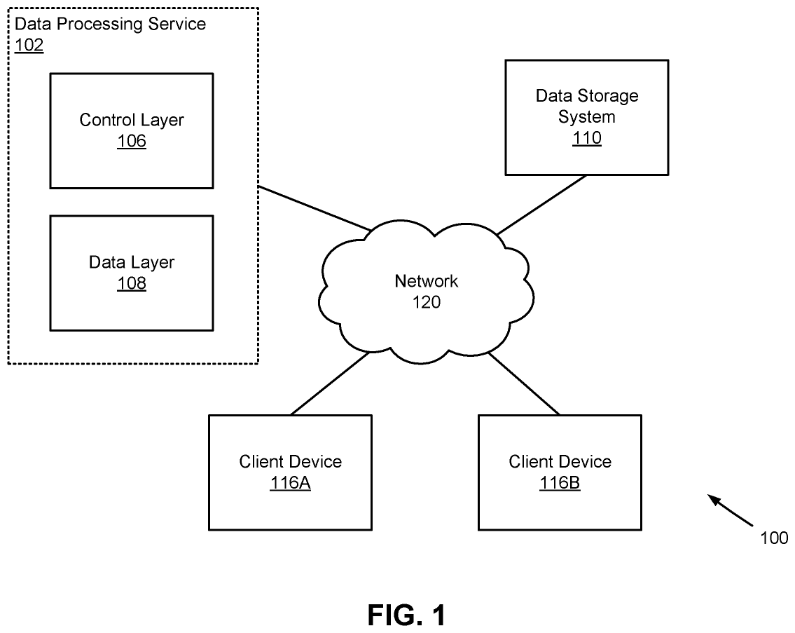

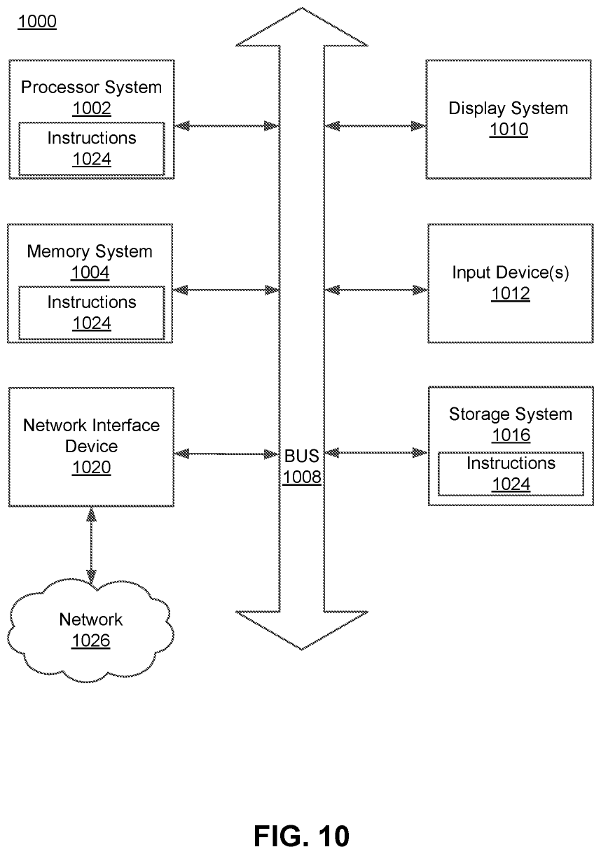

FIG. 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100. The computing systems of the system environment 100 may include some or all of the components (systems (or subsystems)) of a computer system 700 as described with FIG. 10.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning and artificial intelligence requests, and the like, on data stored by the data storage system 110. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 be activated to process the request with certain memory requirements. Responsive to receiving this information, the control layer 106 may send instructions to the data layer 108 to activate the requested number of clusters and configure the clusters according to the requested memory requirements.

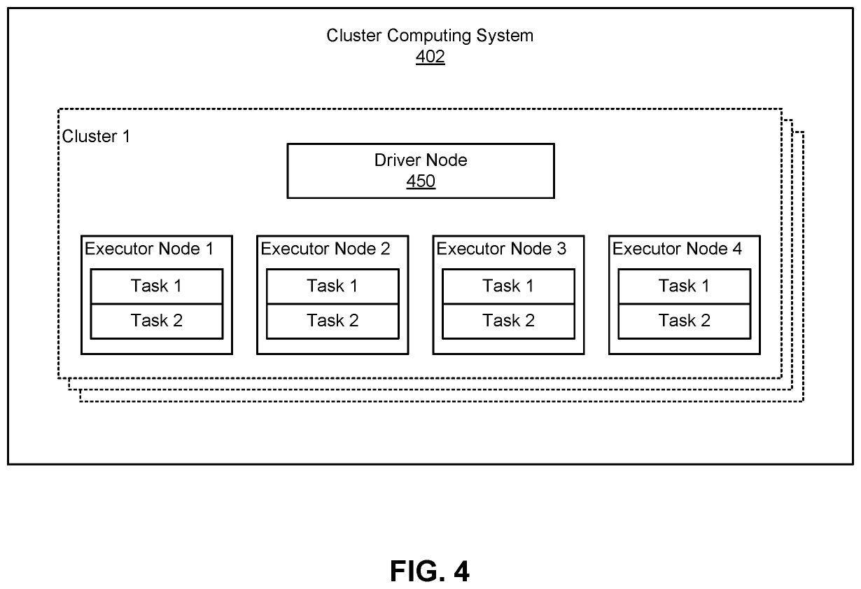

The data layer 108 includes multiple instances of clusters of computing resources that execute one or more jobs received from the control layer 106. Accordingly, the data layer 108 may include a cluster computing system for executing the jobs. An example of a cluster computing system is described in relation to FIG. 4. In one instance, the clusters of computing resources are virtual machines or virtual data centers configured on a cloud infrastructure platform. In one instance, the control layer 106 is configured as a multi-tenant system and the data layers 108 of different tenants are isolated from each other. In one instance, a serverless implementation of the data layer 108 may be configured as a multi-tenant system with strong virtual machine (VM) level tenant isolation between the different tenants of the data processing service 102. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, a cluster in a data layer 108 may include multiple worker nodes that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

In one embodiment, the data processing service 102 receives requests to deploy and train machine-learned models from users. For example, the data processing service 102 may deploy a trained machine-learning model on one or more containers hosted in the data layer 108. As another example, the data processing service 102 may perform a training process to train parameters of the machine-learning model using the powerful computing resources of the data layer 108 in conjunction with a dataset. Many machine-learning models are large-scale models, including more than 1 billion, 10's of billions, 100's of billions, even trillions of parameters, therefore, a high-level of computing resources may be used to deploy or train the large-scale models.

A transformer neural network architecture is a deep neural network which uses attention modules or layers. In one instance, a neural network may be a universal function approximators, which can learn a function using a training process such as stochastic gradient descent (SGD). The transformer architecture can be used for a variety of generative tasks, such as text generation applications, image generation applications, and the like, as well as non-generative tasks, such as classification, detection, embedding-generation, clustering, and the like, where a function needs to be learned. A trained transformer model is configured to receive a set of inputs (e.g., text tokens, image pixels, audio signals) and generate a set of outputs. For example, a transformer architecture may receive a sequence of input tokens that represents a question and generate a sequence of output tokens that represents an answer to the question. In one instance, a transformer architecture includes a set of encoders and/or a set of decoders.

Generally, during a training process of a machine-learning model, the data processing service 102 obtains training data including a plurality of training instances, which may include different modalities of data depending on the type of generation task the architecture is trained for. The data processing service 102 performs a training process to train parameters of the machine-learning model by repeatedly iterating between a forward pass step and a backpropagation step. During the forward pass step, the transformer architecture generates one or more estimated outputs by applying parameters of the transformer architecture for a current iteration to a batch of training instances for the iteration. The data processing service 102 determines a loss function indicating a difference between the one or more estimated outputs and known data in the batch of training instances. During the backpropagation step, gradients are propagated backwards through the neural network. After this a training algorithm, such as SGD or ADAM, is applied to update parameters of the machine-learning model to reduce the loss function. This process is iteratively repeated for the next batch of training instances until a convergence criterion for the parameters is reached.

However, generative transformer architectures typically have a large number of parameters (e.g., greater than 1 billion, greater than 10 billion, greater than 1 trillion, etc.). Training such large models often requires distributed computation across a large set of specialized processors. Furthermore, these networks are often trained using low precision arithmetic. This results in reasonable training times, but often leads to numerically unstable training, making it difficult to actually train these networks. Specifically, during training, “loss spikes” may occur, where the loss function suddenly increases significantly and diverges, resulting in a failure in the training process. The instability occurs frequently in training large-scale architectures. One method to mitigate this instability is to adjust the learning rate whenever a loss spike occurs. However, this method is problematic as it requires shutting down hardware acceleration devices (e.g., graphics processing units (GPU's)) used for the training process, restarting the devices, and/or rewinding the training process to the iteration when the loss spike occurred, which can result in a significant waste of computing resources and time.

Thus, in one embodiment, as described in more detail in conjunction with the machine-learning module 350, the data processing service 102 performs a training process to train a machine-learning transformer architecture. In one embodiment, the transformer architecture includes at least a set of decoders or a set of encoders coupled to receive a set of inputs and generate a set of outputs. In one embodiment, at least one decoder and/or at least one encoder includes an attention block coupled to receive a query, a key, a value and generate an attention output. For one or more iterations, the data processing service 102 obtains a batch of training instances for a current iteration. The parameters of the transformer architecture for the current iteration are applied to a set of inputs obtained from the batch of training instances to generate a set of estimated outputs. In one embodiment, the applying includes obtaining a query, a key, a value from the set of inputs, and applying a clipping function to values of the query, the key, the value. A loss function is determined. The loss function indicates a difference between data in the batch of training instances and the set of estimated outputs, and error terms obtained from the loss function are backpropagated to update the parameters of the transformer architecture. The trained transformer architecture can be deployed to an inference system.

In this manner, the loss spikes can be prevented during the training process of large-scale neural networks, and stability of the training process is improved. Specifically, loss spikes may occur when the “attention entropy” of the attention layer is significantly high. The attention entropy is related to the query and key weight tensor values, and clipping the query, key, and the value indirectly reduce the attention entropy eliminating catastrophic loss spikes during the training process. Moreover, many times, computations for training and performing inference with large-scale neural networks are divided across multiple hardware acceleration devices (e.g., GPU's) during the inference process such that they can be performed in parallel for faster processing, referred to as tensor parallelism. The claimed method and system of clipping the query, the key, the value described herein allow training stability to be improved while still allowing faster processing times to be obtained during inference through tensor parallelism across multiple hardware acceleration devices compared to other mitigation methods.

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data storage system 110 may be managed by the same entity that manages the data processing service 102.

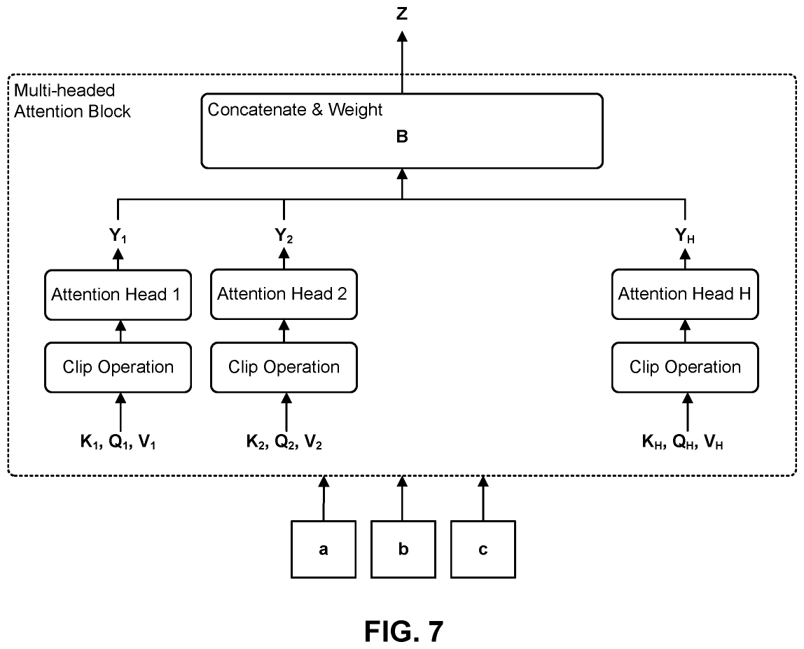

The client devices 116 are computing devices that display information to users and communicates user actions to the systems of the system environment 100. While two client devices 116A, 116B are illustrated in FIG. 1, in practice many client devices 116 may communicate with the systems of the system environment 100. In one embodiment, client devices 116 of the system environment 100 may include some or all of the components (systems (or subsystems)) of a computer system 700 as described with FIG. 7.

In one embodiment, a client device 116 executes an application allowing a user of the client device 116 to interact with the various systems of the system environment 100 of FIG. 1. For example, a client device 116 can execute a browser application to enable interaction between the client device 116 and the control layer 106 via the network 120. In another embodiment, the client device 116 interacts with the various systems of the system environment 100 through an application programming interface (API) running on a native operating system of the client device 116, such as IOS® or ANDROID™.

The network 122 provides a communication infrastructure between the client devices 110 and the online system 130. The network 122 is typically the Internet, but may be any network, including but not limited to a Local Area Network (LAN), a Metropolitan Area Network (MAN), a Wide Area Network (WAN), a mobile wired or wireless network, a private network, or a virtual private network.

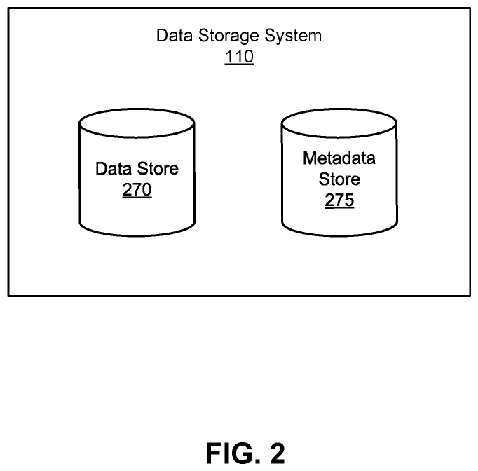

FIG. 2 is a block diagram of an architecture of a data layer 108, in accordance with an embodiment. In one embodiment, the data layer 108 includes a data ingestion module 250. The data layer 108 also includes a data store 270 and a metadata store 275.

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data layer 108. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that include another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity, and may indicate the specific changes to individual records with an indication of whether the record was inserted, deleted, or updated due to the corresponding transaction.

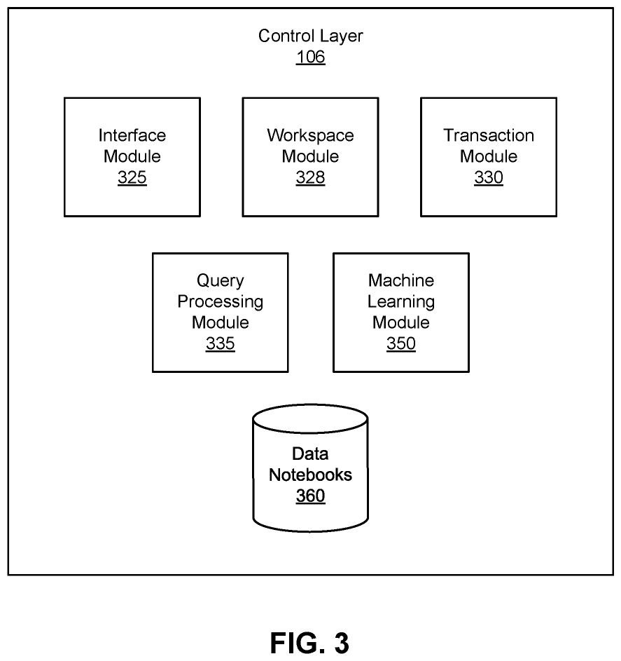

FIG. 3 is a block diagram of an architecture of a control layer 106, in accordance with an embodiment. In one embodiment, the control layer 106 includes an interface module 325, a workspace module 328, a transaction module 330, a query processing module 335, and a machine learning module 350. The control layer 106 also includes a data notebook store 360. The modules 325, 330, 335, 340, and 350 may be structured for execution by a computer system, e.g., 1000 having some or all of the components as described in FIG. 10, such that the computer system 1000 operates in a specified manner as per the described functionality.

The interface module 325 provides an interface and/or a workspace environment where users of client devices 116 (e.g., users associated with tenants) can access resources of the data processing service 102. For example, the user may retrieve information from data tables associated with a tenant, submit data processing requests such as query requests on the data tables, through the interface provided by the interface module 325. The interface provided by the interface module 325 may include notebooks, libraries, experiments, queries submitted by the user. In one embodiment, a user may access the workspace via a user interface (UI), a command line interface (CLI), or through an application programming interface (API) provided by the interface module 325.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

In some embodiments, the interface module 325 provides an interface for users to make requests to train and deploy machine-learning and artificial intelligence (AI) models (e.g., LLMs) in conjunction with the machine learning module 350. For example, the interface module 325 may receive, from a user, the model and a set of training examples. The interface module 325 may also receive constraints on resources to use for training, for example a budget, a number of devices, or memory constraint for training. The control layer 106 may train the model and provide the trained model to the user, for example by deploying the trained model in the data layer 108.

The workspace module 328 deploys workspaces within the data processing service 102. A workspace as defined herein may refer to a deployment in the cloud that functions as an environment for users of the workspace to access assets. An account of the data processing service 102 represents a single entity that can include multiple workspaces. In one embodiment, an account associated with the data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of the data processing service 102 may configure access permissions such that users assigned to a respective workspace are able to access all of the assets of the workspace. As another example, users associated with different subgroups may have different levels of access, for example users associated with a first subgroup may be granted access to all data objects while users associated with a second subgroup are granted access to only a select subset of data objects.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a large number of data files composing the data table, some operations may be relatively inefficient. Thus, a transaction operation may be a compaction operation that combines the records included in one or more data files into a single data file.

The query processing module 335 receives and processes queries that access data stored by the data storage system 110. The query processing module 335 may reside in the control layer 106. The queries processed by the query processing module 335 are referred to herein as database queries. The database queries are specified using a declarative database query language such as the SQL. The query processing module 335 compiles a database query specified using the declarative database query language to generate executable code that is executed. The query processing module 335 may encounter runtime errors during execution of a database query and returns information describing the runtime error including an origin of the runtime error representing a position of the runtime error in the database query. In one embodiment, the query processing module 335 provides one or more queries to appropriate clusters of the data layer 108, and receives responses to the queries from clusters in which the queries are executed.

FIG. 4 is a block diagram of an architecture of a cluster computing system 402 of the data layer 108, in accordance with an embodiment. In some embodiments, the cluster computing system 402 of the data layer 108 includes driver node 450 and worker pool including multiple executor nodes. The nodes may be structured for execution by a computer system, e.g., 700 having some or all of the components as described in FIG. 7, such that the computer system 700 operates in a specified manner as per the described functionality.

The driver node 450 receives one or more jobs for execution, divides a job into job stages, and provides job stages to executor nodes, receives job stage results from the executor nodes of the worker pool, and assembles job stage results into complete job results, and the like. In one embodiment, the driver node receives a request to execute one or more queries from the query processing module 335. The driver node 450 may compile a database query and generate an execution plan. The driver node 450 distributes the query information including the generated code to the executor nodes. The executor nodes execute the query based on the received information.

The worker pool can include any appropriate number of executor nodes (e.g., 4 executor nodes, 12 executor nodes, 256 executor nodes). Each executor node in the worker pool includes one or more execution engines (not shown) for executing one or more tasks of a job stage. In one embodiment, an execution engine performs single-threaded task execution in which a task is processed using a single thread of the CPU. The executor node distributes one or more tasks for a job stage to the one or more execution engines and provides the results of the execution to the driver node 410. According to an embodiment, an executor node executes the generated code for the database query for a particular subset of data that is processed by the database query. The executor nodes execute the query based on the received information from the driver node 450.

Training Transformer Architectures with Clip Operations

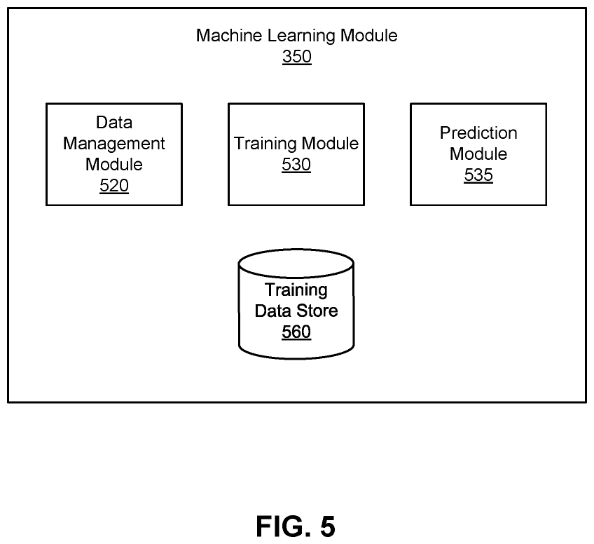

FIG. 5 illustrates a block diagram of an architecture of a machine learning module 350, in accordance with an embodiment. The machine learning module 350 shown by FIG. 5 includes a data management module 520, a training module 530, and a prediction module 535. The machine learning module 350 also includes a training data store 560. In alternative configurations, different and/or additional components may be included in the machine learning module 350.

The data management module 520 manages the training data store 560 of training data that are used to train a set of parameters of the transformer architecture. In one embodiment, when the transformer architecture is a text generation model, the training data store 360 includes multiple instances of data that each include an ordered set of text. The ordered set of text for a training instance may be encoded into an ordered set of tokens, where each token represents a respective text unit (e.g., word, sub-word) in the text for the instance. The tokens represent the text units in a latent space. In another embodiment, when the transformer architecture is an image generation model, the training data store 360 includes multiple instances of data that each include a pair of a text description and a respective image that corresponds to the description in the text. The text is encoded as an ordered set of tokens and the image is encoded as a tensor of pixels or latent pixels, where a latent pixel covers a respective region of pixels in the image.

The training module 530 trains parameters of a transformer architecture during a training process. In one embodiment, the training module 530 trains the transformer architecture by applying a clip function to one or more queries, keys, values that are provided to one or more attention layers. The training module 530 trains parameters of the machine-learning model by repeatedly iterating between a forward pass step and a backpropagation step. During the forward pass step, the transformer architecture generates one or more estimated outputs by applying parameters of the transformer architecture for a current iteration to a batch of training instances for the iteration. The training module 530 determines a loss function that indicates a difference between the one or more estimated outputs and known data in the batch of training instances. During the backpropagation step, gradients are propagated backwards through the neural network. After this a training algorithm, such as SGD or ADAM, is applied to update parameters of the machine-learning model to reduce the loss function. This process is iteratively repeated for the next batch of training instances until a convergence criterion for the parameters is reached.

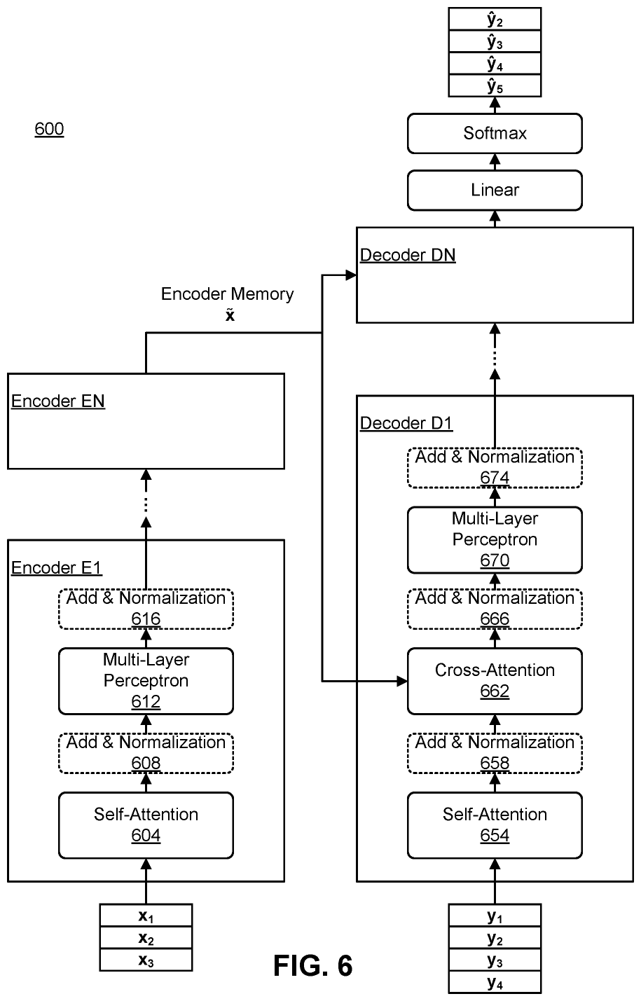

FIG. 6 illustrates an architecture of a transformer architecture, in accordance with an embodiment. As shown in FIG. 6, the example transformer architecture includes a set of N encoders E1, E2, . . . , EN and a set of M decoders D1, D2, . . . , DM coupled to the set of encoders. An encoder is coupled to receive a set of inputs and generate a set of encoded outputs. A decoder is coupled to receive a set of inputs and generate a set of outputs. In one embodiment, the decoder can also be configured to receive the set of inputs and the encoded outputs of the encoders to generate the set of outputs. While FIG. 6 illustrates an example architecture with a set of encoders and a set of decoders as a primary example, it is appreciated that the invention described herein can be applied to other example transformer architectures with a set of decoders for generation (e.g., GPT) or a set of encoders for encoding embeddings (e.g., BERT).

In the example shown in FIG. 6, the machine learning module 530 trains transformer architecture 600 by iterating over batches of training instances at each iteration of the training process. In the example shown in FIG. 6, the transformer architecture 600 is trained to receive input text in French and generate output text in English, and thus, the training data store includes one or more set of training instances that each include a pair of inputs and known outputs. For example, a pair may include a set of inputs representing French text and corresponding known outputs representing English text that is a translation of the French text.

The example instance shown in FIG. 6 processed for a given iteration of the training process illustrates an ordered set of input tokens x₁, x₂, x₃ to the encoders that each represent the words “Comment,” “vas,” “tu?” respectively. For the given iteration, the set of encoders are applied to the set of inputs x₁, x₂, x₃ to generate a set of encoded outputs \tilde{x}. The example instance shown in FIG. 6 processed for a given iteration of training also illustrates an ordered set of input tokens y₁, y₂, y₃, y₄ to the decoders that each represent the words “How,” “are,” “you,” “doing?” respectively in English. The parameters of the set of decoders are applied to the set of inputs y₁, y₂, y₃, y₄ to generate a set of outputs ŷ₂, ŷ₃, ŷ₄, ŷ₅, where ŷᵢ corresponds to the prediction for position i in the output sequence.

A loss function is calculated for the iteration that indicates a difference between the set of outputs ŷ₂, ŷ₃, ŷ₄, ŷ₅ and the corresponding known outputs y₂, y₃, y₄, y₅ for the training instance. The training module 530 computes the loss function and backpropagates error terms form the loss function to update parameters of the transformer architecture 600. This process is repeated for the next remaining iterations until a convergence criterions is reached.

Typically, an encoder or a decoder in the transformer architecture includes one or more attention blocks. An attention block is coupled to receive a key input a, a query input b, and a value input c and generate a set of attention representations. The attention block allows an attention representation of an encoder or decoder to respectively encode or decode an input based on the associations between the respective input to other inputs to the attention block. In one instance, an attention block generates attention representations by applying a key weight matrix Wₖ to the key input a to generate a key K, a query weight matrix W_{q} to the query input b to generate a query Q, and a value weight matrix Wᵥ to the value input c to generate a value V. The key, the query, the value are combined to generate an output matrix Y, where Y may be given by:

$$Y = f ( softmax ( \frac{{QK}^{T}}{c} ) \cdot V ) ,$$

where f(⋅) is any function (parameterized or not) that can be applied to the output of the softmax function. An attention weight matrix B is applied to the output matrix Y to generate the set of attention representations Z. The parameters of the key weight matrix Wₖ, the query weight matrix W_{q}, the value weight matrix Wᵥ, and the attention weight matrix B are learned during the training process of the transformer architecture.

In one embodiment, the transformer architecture applies a clip function to the query, the key, or the value generated in one or more attention layers, such that the values are set to a maximum threshold value if they are above a positive threshold (e.g., +2, +4, +6, +10) or are set to a minimum threshold value they are below a negative threshold (e.g., −2, −4, −6, −10). The values for each of the query, the value, or the key may be clipped or any one or two of the query, the value, or the key may be clipped. For example, only the values for the query and the key may be clipped. In this manner, loss spikes may be prevented during the training process.

In one embodiment, an encoder E may include a self-attention block 604 coupled to receive a key input, a query input, and a value input and generate a set of attention representations. In a self-attention block, each input may be obtained from the set of input tokens x₁, x₂, x₃ or a set of outputs received from a previous encoder. The encoder may also include other blocks including a first add and normalization block 608 placed after the self-attention block 604, a multi-layer perceptron (MLP) block 612 placed after the add and normalization block 608, and a second add and normalization block 616 placed after the MLP block 612.

Similarly, a decoder D may include a self-attention block 654 coupled to receive a key input, a query input, and a value input and generate a set of attention operations. The inputs to the self-attention block 654 may be obtained from the set of input tokens y₁, y₂, y₃, y₄ or a set of outputs received from a previous decoder. The decoder may also include other blocks including a first add and normalization block 658 placed after the self-attention block 654, a cross-attention block 662 placed after the add and normalization block 658, a second add and normalization block 666 placed after the cross-attention block 662, a MLP block 670 placed after the cross-attention block 662, and a third add and normalization block 674 placed after the MLP block 670. The input query to the cross-attention block 662 may be obtained from the set of outputs received from the previous block (e.g., add and normalization block 658), and the input key and input value may be obtained from the encoded outputs \tilde{x} received from the set of encoders.

FIG. 7 illustrates an architecture of an attention block with multi-head attention, in accordance with an embodiment. In one embodiment, the transformer architecture includes one or more attention blocks with a multi-headed structure. For example, any one or more of or all of the self-attention blocks in an encoder or the self-attention blocks or the encoder-decoder attention blocks in a decoder may have the multi-headed structure.

As shown in FIG. 7, an attention block with a multi-headed structure is coupled to receive a key input a, a query input b, and a value input c and generate a set of attention representations. Specifically, the multi-headed structure includes a plurality of attention heads. Each attention head i is coupled to receive its own key Kᵢ, query Qᵢ, value Vᵢ, and generate a respective output matrix Yᵢ by tensor multiplying the key Kᵢ with the query Qᵢ, applying a softmax function, and tensor multiplying the value Vᵢ to the output. In one embodiment, a clip operation is applied to the key, query, value to clip values that have an absolute value above a predetermined threshold (e.g., 2, 4, 6, 10) to control the attention entropy to improve stability during training. After, the output matrices Y₁, Y₂, . . . , Y_{H} are concatenated together, and an attention weight matrix B is applied to generate the set of attention operations Z.

While FIG. 6 illustrates a primary example of a transformer architecture having a set of encoders and decoders, it is appreciated that the method of clipping query, key, and value values can be applied to any transformer architecture that is configured with one or more attention blocks. For example, the method and system described herein can be applied to large language models (LLM's) with a set of decoders, such as generative pre-trained transformers (GPT) or encoding models with a set of encoders, such as bi-directional encoding representations from transformers (BERT). As another example, the transformer architecture may be a cross-modality generation model such as a text-to-image generation model, an image-to-text generation model, a text-to-audio generation model, and the like.

For example, the method and system described herein can also be applied to clipping the query, the key, the values in one or more attention blocks of a diffusion-based generation model that is configured to receive latent representations of, for example, an image and incrementally introduce noise to the latent representation for a predetermined number (e.g., 30, 50, 100, etc.) of iterations to generate noisy representations. An attention block in the diffusion-based generation model may be coupled to receive a query input representing a potential image to be generated, and a key input, a value input obtained from encoding a text description for the image to be generated. In such an embodiment, after generating the key, the query, and the value for the attention block, the values may be clipped according to a clip operation, such that any values outside a certain interval are set to the interval edges. For example, when the clip operation is performed for an interval [−6, +6], any values of the query, the key, or the value that are above +6 are set to +6, and any values that are below −6 are set to −6.

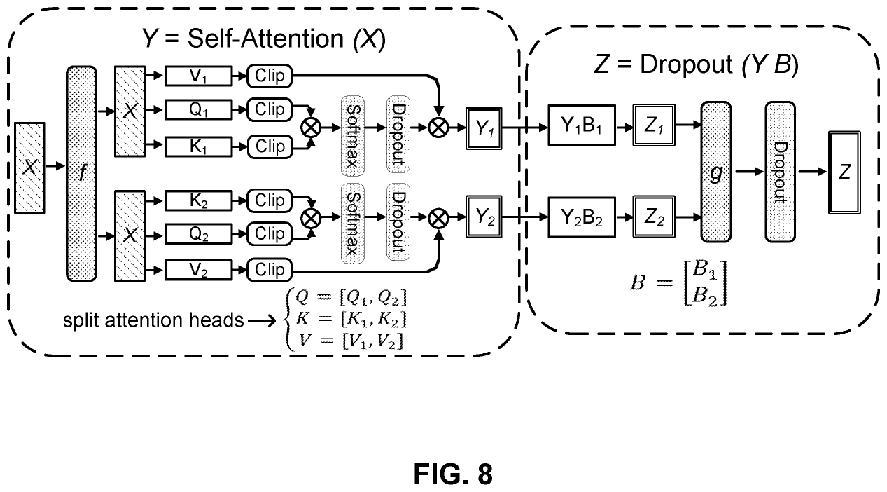

FIG. 8 illustrates an example process of computing the attention layer and attention outputs on two hardware acceleration devices, in accordance with an embodiment. As described above, in many instances, computations for large-scale neural networks during inference (or in some cases, training) are divided across multiple hardware acceleration devices (e.g., GPU's) such that they can be performed with tensor parallelism. In other words, different subsets or portions of the computation required for performing the attention block are divided across multiple acceleration devices. Specifically, FIG. 8 illustrates computation of the attention block on two hardware acceleration devices, GPU 1 and GPU 2. In one embodiment, the computations for generating the output matrix Y for a respective attention head is performed on a respective acceleration device. As illustrated in FIG. 8, the output matrix Y₁ for attention head 1 is generated by performing a scatter (i.e., copying and providing) operation on the set of inputs X, generating the key K₁, the query Q₁, the value V₁ for attention head 1, and performing the matrix multiplications to generate the output matrix Y₁. Similar operations can be performed for attention head 2 to generate output matrix Y₂.

In one embodiment, the attention weight matrix B are applied to the output matrices from the attention heads using row-wise parallelism. As shown in FIG. 8, B₁ includes weights for a first subset of rows of the attention weight matrix, and B₂ includes weights for a second subset of rows of the attention weight matrix. On the first device, Y₁ is tensor multiplied with B₁ to generate Z₁, and Y₂ is tensor multiplied with B₂ to generate Z₂. An aggregation operation if performed to combine the Z₁ and Z₂ matrices to generate the attention representation Z.

In particular, one method of mitigating loss spikes is to control or adjust the output of tensor multiplying the query Qᵢ and the key Kᵢ for an attention head i, for example, by regularizing or performing a layer normalization operation on the multiplied tensor. However, operations like layer normalization are aggregated across the entire set of attention heads, and if used in training to train parameters of the transformer architecture, is typically required during an inference process of the transformer architecture as well. This mitigation method requires first gathering (or concatenating) the multiplied tensors across the set of acceleration devices, performing the layer normalization, and scattering (or providing copies) the output of the normalization to each acceleration device, leading to bandwidth-bottlenecks arising from retrieving and providing data between the multiple GPU's during the inference process. This process may significantly diminish the effects of tensor parallelism.

When the keys, queries, and/or values are clipped by the clipping function, the transformer architecture may or may not implement the clipping function during the inference process. Regardless of whether the clipping function is applied or not, such an operation does not affect tensor parallelism because a separate gathering and scattering step is not required like the layer normalization regularization step. Therefore, as described above, a clipping operation is performed on the keys Kᵢ, queries Qᵢ, and/or values Vᵢ for each attention head at each acceleration device, to control loss spikes but without a separate additional gathering and scattering step. A clip operation is relatively inexpensive to perform on a hardware acceleration device. In this manner, the technical advantages of tensor parallelism to perform distributed and faster processing can be maintained while improving training stability.

In one embodiment, the training process is performed such that the clip operation is applied for one or more iterations but is not applied to one or more iterations near the end of the training process. For example, for a total number of 1,000,000 iterations, the clip operation may be performed for the first 900,000 iterations but is not applied for the last 100,000 iterations. Since loss spikes primarily occur during a middle interval of training, the clip operation may be applied during the middle interval but skipped for a remaining number of iterations.

Returning to FIG. 5, the prediction module 535 deploys the trained transformer architecture for performing inference tasks from users. For example, the model may be deployed on a cluster computing system 402 on cloud infrastructure. For an inference process, the transformer architecture is configured to receive a set of inputs (e.g., request or prompt from a user) and generate a set of output tokens. In one embodiment, the output tokens are auto-regressively generated, meaning that an output token generated at a previous iteration is the input to the set of decoders for a next iteration, until an end token signaling the end of generation is generated. In one embodiment, the clip operation may be applied to queries, keys, and values. In another embodiment, the clip operation is not applied during the inference process.

### Method of Training Transformer Architecture Using Clip Operations

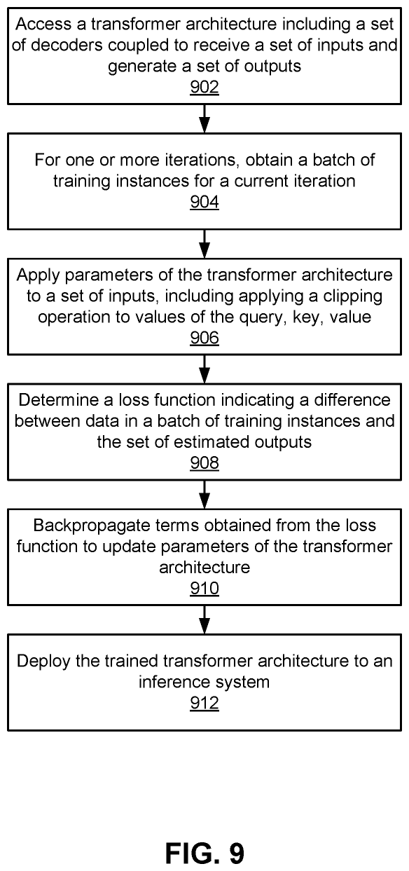

FIG. 9 illustrates a flowchart for performing a method of training a transformer architecture, in accordance with an embodiment. In one embodiment, the process of FIG. 9 is performed by various modules of the online system 130. Other entities may perform some or all of the steps of the process in other embodiments. Likewise, embodiments may include different and/or additional steps, or perform the steps in different orders.

The data processing service 102 accesses 902 a transformer architecture including a set of decoders coupled to receive a set of inputs and generate a set of outputs. At least one decoder includes an attention block coupled to receive a query, a key, and a value and generate an attention output. For one or more iterations of the training process, the data processing service 102 obtains 904 a batch of training instances for a current iteration. The transformer architecture applies 906 parameters of the transformer architecture for the current iteration to a set of inputs obtained from the batch of training instances to generate a set of estimated outputs. In one embodiment, the applying comprises obtaining a query, a key, and a value from the set of inputs, and applying a clipping function to values of the query, the key, and the value.

The data processing service determines 908 a loss function determining a loss function indicating a difference between data in the batch of training instances and the set of estimated outputs. The data processing service 102 performs a training process that backpropagate 910 terms obtained from the loss function to update the parameters of the transformer architecture. The data processing service 102 deploys 912 the trained transformer architecture to an inference system.

Turning now to FIG. 10, illustrated is an example machine to read and execute computer readable instructions, in accordance with an embodiment. Specifically, FIG. 10 shows a diagrammatic representation of the data processing service 102 (and/or data processing system) in the example form of a computer system 1000. The computer system 1000 is structured and configured to operate through one or more other systems (or subsystems) as described herein. The computer system 1000 can be used to execute instructions 1024 (e.g., program code or software) for causing the machine (or some or all of the components thereof) to perform any one or more of the methodologies (or processes) described herein. In executing the instructions, the computer system 1000 operates in a specific manner as per the functionality described. The computer system 1000 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 1000 may be a server computer, a client computer, a personal computer (PC), a tablet PC, a smartphone, an internet of things (IoT) appliance, a network router, switch or bridge, or other machine capable of executing instructions 1024 (sequential or otherwise) that enable actions as set forth by the instructions 1024. Further, while only a single machine is illustrated, the term “machine” shall also be taken to include any collection of machines that individually or jointly execute instructions 1024 to perform any one or more of the methodologies discussed herein.

The example computer system 1000 includes a processing system 1002. The processor system 1002 includes one or more processors. The processor system 1002 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 702 executes an operating system for the computer system 1000. The computer system 700 also includes a memory system 1004. The memory system 1004 may include or more memories (e.g., dynamic random access memory (RAM), static RAM, cache memory). The computer system 1000 may include a storage system 1016 that includes one or more machine readable storage devices (e.g., magnetic disk drive, optical disk drive, solid state memory disk drive).

The storage unit 1016 stores instructions 1024 (e.g., software) embodying any one or more of the methodologies or functions described herein. For example, the instructions 1024 may include instructions for implementing the functionalities of the machine learning module 350. The instructions 1024 may also reside, completely or at least partially, within the memory system 1004 or within the processing system 1002 (e.g., within a processor cache memory) during execution thereof by the computer system 1000, the main memory 1004 and the processor system 1002 also constituting machine-readable media. The instructions 1024 may be transmitted or received over a network 1026, such as the network 1026, via the network interface device 1020.

The storage system 1016 should be taken to include a single medium or multiple media (e.g., a centralized or distributed database, or associated caches and servers communicatively coupled through the network interface system 1020) able to store the instructions 1024. The term “machine-readable medium” shall also be taken to include any medium that is capable of storing instructions 1024 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 1000 can include a display system 1010. The display system 1010 may driver firmware (or code) to enable rendering on one or more visual devices, e.g., drive a plasma display panel (PDP), a liquid crystal display (LCD), or a projector. The computer system 1000 also may include one or more input/output systems 1012. The input/output (IO) systems 1012 may include input devices (e.g., a keyboard, mouse (or trackpad), a pen (or stylus), microphone) or output devices (e.g., a speaker). The computer system 1000 also may include a network interface system 1020. The network interface system 1020 may include one or more network devices that are configured to communicate with an external network 1026. The external network 1026 may be a wired (e.g., ethernet) or wireless (e.g., WiFi, BLUETOOTH, near field communication (NFC).

The processor system 1002, the memory system 1004, the storage system 1016, the display system 1010, the IO systems 1012, and the network interface system 1020 are communicatively coupled via a computing bus 1008.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
accessing a transformer architecture including a set of decoders coupled to receive a set of inputs and generate a set of outputs, wherein at least one decoder includes an attention block, the attention block coupled to receive a query, a key, and a value and generate an attention output;
for one or more iterations:
obtaining a batch of training instances for a current iteration,
applying parameters of the transformer architecture for the current iteration to a set of inputs obtained from the batch of training instances to generate a set of estimated outputs, the applying comprising for an attention block:
obtaining a query, a key, and a value from the set of inputs, and
applying a clipping operation to values of the query, the key, and the value,
determining a loss function indicating a difference between data in the batch of training instances and the set of estimated outputs, and
backpropagating terms obtained from the loss function to update the parameters of the transformer architecture; and
deploying the trained transformer architecture to an inference system.

2. The method of claim 1, wherein the clipping operation is associated with an interval or values, and applying the clipping operation comprises setting a value to a first value if the value is below a first threshold of the interval, or setting the value to a second value if the value is above a second threshold of the interval.

3. The method of claim 1, wherein the transformer architecture is coupled to receive a set of input tokens representing text as the set of inputs and generate a set of output tokens representing text as the set of outputs.

4. The method of claim 1, wherein the transformer architecture is coupled to receive a set of input tokens representing text as the set of inputs and generate a set of output pixels or latent pixels representing an image as the set of outputs.

5. The method of claim 1, further comprising for another one or more iterations, training the parameters of the transformer architecture, wherein the clipping operation is not applied for the another one or more iterations.

6. The method of claim 1, wherein applying the parameters for the attention block comprises:
generating a first output matrix on a first hardware acceleration device for a first attention head by applying the clipping operation to the values of the query, the key, and the value for the first attention head, and combining the clipped query, key, and value to generate the first output matrix;
tensor multiplying the first output matrix with a first subset of weights from an attention weight matrix to generate a first subset of attention representations;
generating a second output matrix on a second hardware acceleration device for a second attention head by applying the clipping operation to values of a second query, a second key, and a second value for a second attention head, and combining the clipped second query, second key, and second value to generate the second output matrix;
tensor multiplying the second output matrix with a second subset of weights from the attention weight matrix to generate a second subset of attention representations; and
combining the first subset of attention representations with the second subset of attention representations.

7. The method of claim 1, wherein each of the first hardware acceleration device and the second hardware acceleration device are graphics processor units (GPU's).

8. A non-transitory computer readable storage medium comprising stored program code, the program code comprising instructions, the instructions when executed causes a processor system to:
access a transformer architecture including a set of decoders coupled to receive a set of inputs and generate a set of outputs, wherein at least one decoder includes an attention block, the attention block coupled to receive a query, a key, and a value and generate an attention output;
for one or more iterations:
obtain a batch of training instances for a current iteration,
apply parameters of the transformer architecture for the current iteration to a set of inputs obtained from the batch of training instances to generate a set of estimated outputs, the applying comprising for an attention block:
obtaining a query, a key, and a value from the set of inputs, and
applying a clipping operation to values of the query, the key, and the value,
determine a loss function indicating a difference between data in the batch of training instances and the set of estimated outputs, and
backpropagate terms obtained from the loss function to update the parameters of the transformer architecture; and
deploy the trained transformer architecture to an inference system.

9. The non-transitory computer readable storage medium of claim 8, wherein the clipping operation is associated with an interval or values, and applying the clipping operation comprises setting a value to a first value if the value is below a first threshold of the interval, or setting the value to a second value if the value is above a second threshold of the interval.

10. The non-transitory computer readable storage medium of claim 8, wherein the transformer architecture is coupled to receive a set of input tokens representing text as the set of inputs and generate a set of output tokens representing text as the set of outputs.

11. The non-transitory computer readable storage medium of claim 8, wherein the transformer architecture is coupled to receive a set of input tokens representing text as the set of inputs and generate a set of output pixels or latent pixels representing an image as the set of outputs.

12. The non-transitory computer readable storage medium of claim 8, the instructions further causing the processor to for another one or more iterations, train the parameters of the transformer architecture, wherein the clipping operation is not applied for the another one or more iterations.

13. The non-transitory computer readable storage medium of claim 8, wherein the instructions further cause the processor to:
generate a first output matrix on a first hardware acceleration device for a first attention head by applying the clipping operation to the values of the query, the key, and the value for the first attention head, and combining the clipped query, key, and value to generate the first output matrix;
tensor multiply the first output matrix with a first subset of weights from an attention weight matrix to generate a first subset of attention representations;
generate a second output matrix on a second hardware acceleration device for a second attention head by applying the clipping operation to values of a second query, a second key, and a second value for a second attention head, and combining the clipped second query, second key, and second value to generate the second output matrix;
tensor multiply the second output matrix with a second subset of weights from the attention weight matrix to generate a second subset of attention representations; and
combine the first subset of attention representations with the second subset of attention representations.

14. The non-transitory computer readable storage medium of claim 8, wherein each of the first hardware acceleration device and the second hardware acceleration device are graphics processor units (GPU's).

15. A computer system, comprising:
a computer processor; and
a non-transitory computer readable storage medium comprising stored instructions that when executed by the computer processor, cause the computer system to:
access a transformer architecture including a set of decoders coupled to receive a set of inputs and generate a set of outputs, wherein at least one decoder includes an attention block, the attention block coupled to receive a query, a key, and a value and generate an attention output;
for one or more iterations:
obtain a batch of training instances for a current iteration,
apply parameters of the transformer architecture for the current iteration to a set of inputs obtained from the batch of training instances to generate a set of estimated outputs, the applying comprising for an attention block:
obtaining a query, a key, and a value from the set of inputs, and
applying a clipping operation to values of the query, the key, and the value,
determine a loss function indicating a difference between data in the batch of training instances and the set of estimated outputs, and
backpropagate terms obtained from the loss function to update the parameters of the transformer architecture; and
deploy the trained transformer architecture to an inference system.

16. The computer system of claim 15, wherein the clipping operation is associated with an interval or values, and applying the clipping operation comprises setting a value to a first value if the value is below a first threshold of the interval, or setting the value to a second value if the value is above a second threshold of the interval.

17. The computer system of claim 15, wherein the transformer architecture is coupled to receive a set of input tokens representing text as the set of inputs and generate a set of output tokens representing text as the set of outputs.

18. The computer system of claim 15, wherein the transformer architecture is coupled to receive a set of input tokens representing text as the set of inputs and generate a set of output pixels or latent pixels representing an image as the set of outputs.

19. The computer system of claim 15, the instructions further causing the computer system to for another one or more iterations, train the parameters of the transformer architecture, wherein the clipping operation is not applied for the another one or more iterations.

20. The computer system of claim 15, wherein the instructions further cause the computer system to:
generate a first output matrix on a first hardware acceleration device for a first attention head by applying the clipping operation to the values of the query, the key, and the value for the first attention head, and combining the clipped query, key, and value to generate the first output matrix;
tensor multiply the first output matrix with a first subset of weights from an attention weight matrix to generate a first subset of attention representations;
generate a second output matrix on a second hardware acceleration device for a second attention head by applying the clipping operation to values of a second query, a second key, and a second value for a second attention head, and combining the clipped second query, second key, and second value to generate the second output matrix;
tensor multiply the second output matrix with a second subset of weights from the attention weight matrix to generate a second subset of attention representations; and
combine the first subset of attention representations with the second subset of attention representations.
